(19) United States
(12) Patent Application Publication
(10) Pub. No.: US 2017/0317756 A1
(43) Pub. Date: Nov. 2, 2017

(54) OPTICAL AMPLIFIER FOR SUBSEA CONTROL SYSTEMS

(71) Applicant: GE Oil & Gas UK Limited, Bristol (GB)

(72) Inventors: Keith David COVENTRY, Bristol (GB); Silviu PUCHIANU, Bristol (GB)

(73) Assignee: GE Oil & Gas UK Limited, Bristol (GB)

(21) Appl. No.: 15/521,433

(22) PCT Filed: Oct. 16, 2015
(86) PCT No.: PCT/EP2015/074020

§ 371 Date: Apr. 24, 2017

(30) Foreign Application Priority Data
Oct. 24, 2014 (GB) 1418962.5

(51) Int. Cl. H04B 10/291; H04B 13/02

(52) U.S. Cl. CPC H04B 10/2912; H04B 13/02

(57) ABSTRACT

An optical amplifier comprising: an optical coupler configured to receive a communication signal and couple said communication signal to an optical connector of a doped optical fibre; and at least one electrical to optical data converter connected to the optical coupler to provide pump radiation thereto.

### BACKGROUND

This invention relates to an optical amplifier and a method of boosting a communication signal in a doped optical fibre. In one example, it relates to an optical amplifier for use in a subsea control system of an underwater hydrocarbon extraction facility.

In the subsea oil and gas industry, as readily accessible deposits are depleted there is a requirement to explore further and enable production from sites further afield. This necessitates an ability to send and receive communications over increasingly longer distances. Many subsea systems now rely on fibre optic systems for communication.

Typical solutions for boosting optical fibre data traffic include erbium doped fibre amplifiers and Raman amplifiers, and these are well-known in the art. Both of these solutions involve expensive and complicated devices to implement, and have unproven long term reliability. Reliability is an essential feature of subsea communication systems due to the cost and inconvenience of replacing subsea parts, and so an improved solution is desirable for this field.

### BRIEF DESCRIPTION OF THE INVENTION

The solution provided by embodiments of the present invention is a novel application for existing devices, namely electrical to optical data converters (EODCs). An EODC is a device commonly used for optical communication that translates optical Tx/Rx data signals into electrical Tx/Rx data signals and vice-versa.

However, to date EODCs have only been used for data transmission. Embodiments of the present invention uses EODCs for optical signal amplification.

It is an aim of embodiments of the present invention to provide a simpler, less expensive and more reliable method of boosting an optical signal than that provided by prior art devices.

In accordance with a first aspect of the present invention there is provided an optical amplifier comprising:

a. an optical coupler configured to receive a communication signal and couple;

b. said communication signal to an optical connector of a doped optical fibre; and

c. at least one electrical to optical data converter connected to the optical coupler to provide pump radiation thereto.

In accordance with a second aspect of the present invention there is provided a method of boosting a communication signal in a doped optical fibre, the method comprising the steps of:

a. providing an optical coupler configured to receive a communication signal and couple said communication signal to an optical connector of a doped optical fibre; and

b. providing at least one electrical to optical data converter connected to the optical coupler to provide pump radiation thereto.

The at least one electrical to optical data converter could be a small form-factor pluggable device.

The optical fibre could be doped with erbium.

The optical coupler could receive the communication signal from an electrical to optical data converter which communicates with a modem. Said modem could be a modem of an underwater hydrocarbon extraction facility.

The optical amplifier could be housed in a power and communications distribution module of an underwater hydrocarbon extraction facility.

### BRIEF DESCRIPTION OF THE DRAWINGS

The invention will now be described with reference to the accompanying drawings, in which:

FIG. 1 schematically shows a subsea communication system including an exemplary optical amplifier in accordance with the present invention.

FIG. 1 schematically shows a subsea communication system 1 in accordance with an embodiment of the present invention. The communication system 1 includes a long offset umbilical 2, which runs from a surface location (topside) to a subsea location.

### DETAILED DESCRIPTION OF THE INVENTION

The umbilical 2 is connected to an optical flying lead 3 via a first optical connector 4. The optical flying lead 3 comprises a doped optical fibre. In this embodiment, the optical fibre is doped with erbium, although other dopants may be used. The first optical connector 4 is a connection on a subsea umbilical termination unit (not shown).

The optical flying lead 3 is also connected via a second optical connector 5 to a communications EODC 6. The communications EODC 6 converts optical signals from the second optical connector 4 into electrical Rx communication signals which may then be passed to a subsea modem 7.

The modem 7 also provides electrical Tx communication signals back to the communications EODC 6, which converts the electrical Tx communication signals into optical Tx communication signals which may then be passed to an optical coupler 8 for transmission via the second optical connector 5 to the optical flying lead 3, and then via the optical connector 4 and the umbilical 2 back to a surface location.

The distance over which the optical Tx (and topside-to-subsea Rx) communication signals can travel in optical fibre can be extended using a known physics principle, which will now be briefly described.

In doped optical fibre, depending on the doping agent (erbium, in the present example) when a first electromagnetic (EM) radiation of a first specific wavelength is passed through the doped fibre (one of them being 1480 nm for erbium doped fibre), part of the energy of the EM radiation is transferred to the erbium atoms in the optical fibre and energy is stored thereby. If, simultaneously, a second EM radiation of a second specific wavelength (1550 nm for example) is passed through the same doped fibre, the stored energy is transferred from the erbium atoms to this second EM radiation. The result is the power amplification of the second EM radiation.

In prior art systems the first EM radiation is provided by a single high-power laser operating at the first specific wavelength. Embodiments of the present invention replaces this laser with one or more EODC.

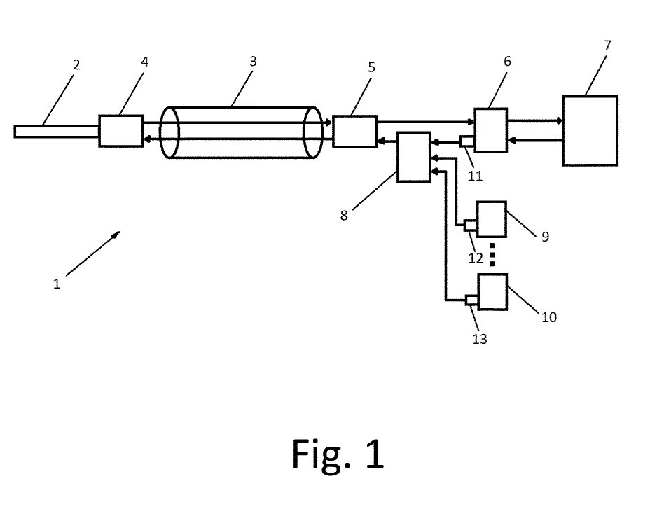

In FIG. 1 a first pump EODC 9 is shown providing pump radiation to the optical coupler 8. A n^{th} pump EODC 10 is also shown providing pump radiation to the optical coupler 8. Dots are used to indicate the intervening second to (n−1)^{th} pump EODCs which are not shown, but which connect to the optical coupler 8 in a similar way to the first and n^{th} pump EODCs. The number n is chosen based on the magnitude of the gain which is desired to be provided to the communication signal. More pump EODCs 9, 10 corresponds to more pump power that results in a greater gain.

The communications EODC 6 and the first n^{th} pump EODCs 9, 10 each have a respective optical isolator 11, 12, 13 connected to their respective transmit ports which allows electromagnetic radiation to pass though one way. This prevents EM radiation from one EODC from entering the transmit port of another EODC.

Components to the right of second optical connector 5 as shown in FIG. 1 may be housed in a communications electronics module (CEM) within a PCDM, (power and communication distribution module).

In the example of FIG. 1, the optical flying lead 3 contains a doped erbium fibre. The pump EODCs 9, 10 provide EM radiation at a wavelength of 1480 or 980 nm that excites the erbium ions and causes the communication signal from the communications EODC 6 to be amplified through optical amplification. The amplification attained through this technique is substantial. Using n=2, the amplification gained is in the order of about 10 dB, possibly higher, depending on the type of EODCs and fibre used. On a straight fibre run this would equate to a minimum of a 50 km range extension. The addition of more pump EODCs would make even greater amplification margins possible.

There are numerous advantages associated with embodiments of the present invention. For example, the use of EODCs for optical signal boosting means that the amplification is determined by the power of the boost EM radiation and also by the number of boost EODCs used. This means that more or fewer EODCs can be provided as required by the application at hand, giving improved scalability when compare with prior art optical amplification techniques using a single high-power laser to provide pump radiation. The replacement of a single laser with lower power EODCs also improves the thermal management properties of the subsea PCDM by separating out a large power source into several smaller power sources.

Embodiments of the invention also provides long offset repeater-less optical communication without the use of dedicated optical amplifiers that are expensive, complicated, in need of qualification and ruggedisation and have unknown reliability.

Embodiments of the invention provides a simple, small-size, low-power, reliable configuration that utilises existing and proven off-the-shelf optical technology (EODCs, doped fibre, etc.).

There is no need for doped fibre in the long offset umbilical, if the doped fibre flying lead is connected in the subsea control module (SCM) or in-between SCM and subsea umbilical termination assembly.

The flying lead doped fibre is retrievable. This increases the flexibility of the system, as rather than having to pull the whole PCDM up to the surface and then open it up, change out the fibre etc. only the cable would be need to be swapped out for another one.

Embodiments of the invention requires minimal changes to the existing configuration of many subsea communication systems already deployed, and apart from off-the-shelf EODCs no active components need to be incorporated into the subsea communication system or cabling. This gives embodiments of the invention the capability to be retro-fitted on existing communications systems.

The invention is not limited to the specific embodiments disclosed above, and other possibilities will be apparent to those skilled in the art. For example, wavelengths of EM radiation other than those specified may be used, and dopants other than erbium may be used in the optical fibre.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

What is claimed is:

1. An optical amplifier comprising:
an optical coupler configured to receive a communication signal and couple the communication signal to an optical connector of a doped optical fiber; and
at least one electrical to optical data converter connected to the optical coupler to provide pump radiation thereto.

2. The optical amplifier according to claim 1, wherein the at least one electrical to optical data converter is a small form-factor pluggable device.

3. The optical amplifier according to claim 1, wherein the optical fiber is doped with erbium.

4. The optical amplifier according to claim 1, wherein the optical coupler receives the communication signal from an electrical to optical data converter which communicates with a modem.

5. The optical amplifier according to claim 4, wherein the modem is a modem of an underwater hydrocarbon extraction facility.

6. The optical amplifier according to claim 1, wherein the optical amplifier is housed in a power and communications distribution module of an underwater hydrocarbon extraction facility.

7. A method of boosting a communication signal in a doped optical fiber, the method comprising:
providing an optical coupler configured to receive a communication signal and couple the communication signal to an optical connector of a doped optical fiber; and
providing at least one electrical to optical data converter connected to the optical coupler to provide pump radiation thereto.

8. The method according to claim 7, wherein the at least one electrical to optical data converter is a small form-factor pluggable device.

9. The method according to claim 7, wherein the optical fiber is doped with erbium.

10. The method according to claim 7, wherein the optical coupler receives the communication signal from an electrical to optical data converter which communicates with a modem.

11. The method according to claim 10, wherein the modem is a modem of an underwater hydrocarbon extraction facility.

12. The method according to claim 7, wherein the optical amplifier is housed in a power and communications distribution module of an underwater hydrocarbon extraction facility.
